(19) United States
(12) Patent Application Publication
(10) Pub. No.: US 2015/0117513 A1
(43) Pub. Date: Apr. 30, 2015

(54) BANDWIDTH REDUCTION SYSTEM AND METHOD

(71) Applicant: Google Inc., Mountain View, CA (US)

(72) Inventors: Randall Sarafa, San Francisco, CA (US); Frank Petterson, Mountain View, CA (US); Aaron Eidelson, Mountain View, CA (US); Eryn Maynard, Mountain View, CA (US); Kathryn Cushing, San Francisco, CA (US)

(73) Assignee: Google Inc., Mountain View, CA (US)

(21) Appl. No.: 14/066,502

(22) Filed: Oct. 29, 2013

(51) Int. Cl. H04L 29/06

(52) U.S. Cl. CPC H04L 65/601
USPC 375/240.01

(57) ABSTRACT

A method and computing system for receiving a multi-frame video from a first user for transmission to a second user. A plurality of video frames included within the multi-frame video is selected. A reduced-bandwidth sample of the multi-frame video is generated from the plurality of video frames. The reduced-bandwidth sample is provided to the second user.

### TECHNICAL FIELD

This disclosure relates to bandwidth reduction methodologies and, more particularly, to video bandwidth reduction methodologies.

### BACKGROUND

The Internet currently allows for the free exchange of ideas and information in a manner that was unimaginable only a couple of decades ago. One such use for the Internet is as a communication medium, whether it is via one-on-one exchanges or multi-party exchanges. For example, two individuals may exchange private emails with each other. Alternatively, multiple people may participate on a public website in which they may post entries that are published for multiple people to read. Examples of such websites may include but are not limited to product/service review sites and topical blogs.

Another such use of the Internet is to allow people to communicate with each other via social networks, wherein users may exchange photographs and videos with each other. Unfortunately, when sending videos between users within a social network, the videos may be of considerable length and size. Further, such videos may only be viewable once the downloading of the video has been completed (which may take considerable time and bandwidth). Accordingly, in order for a user to preview a video sent to them by another user, the entire video must be downloaded first, which may frustrate the downloader. For example, User A may send a video to User B and User B may download the same; only to find out that the video is of a cat playing a keyboard (which User B has no interest in).

### SUMMARY OF DISCLOSURE

In one implementation, a computer-implemented method includes receiving a multi-frame video from a first user for transmission to a second user. A plurality of video frames included within the multi-frame video is selected. The plurality of video frames are interspersed throughout the multi-frame video. A reduced-bandwidth sample of the multi-frame video is generated from the plurality of video frames. The reduced-bandwidth sample of the multi-frame video is an animated GIF file. The reduced-bandwidth sample is provided to the second user. The second user is enabled to render the reduced-bandwidth sample, thus allowing the second user to preview the multi-frame video prior to downloading the multi-frame video. A request for the multi-frame video is received from the second user. In response to receiving the request, the multi-frame video is provided to the second user.

In another implementation, a computer-implemented method includes receiving a multi-frame video from a first user for transmission to a second user. A plurality of video frames included within the multi-frame video is selected. A reduced-bandwidth sample of the multi-frame video is generated from the plurality of video frames. The reduced-bandwidth sample is provided to the second user.

One or more of the following features may be included. The second user may be enabled to render the reduced-bandwidth sample, thus allowing the second user to preview the multi-frame video prior to downloading the multi-frame video. A request for the multi-frame video may be received from the second user. In response to receiving the request, the multi-frame video may be provided to the second user.

The reduced-bandwidth sample of the multi-frame video may be an animated GIF file. The plurality of video frames may be interspersed throughout the multi-frame video. The plurality of video frames may be evenly spaced throughout the multi-frame video. The reduced-bandwidth sample may be configured to be rendered on a wireless client electronic device. The first user and the second user may be members of a social network. The second user may be wirelessly coupled to the social network.

In another implementation, a computing system including a processor and memory is configured to perform operations including receiving a multi-frame video from a first user for transmission to a second user. A plurality of video frames included within the multi-frame video is selected. A reduced-bandwidth sample of the multi-frame video is generated from the plurality of video frames. The reduced-bandwidth sample is provided to the second user.

One or more of the following features may be included. The second user may be enabled to render the reduced-bandwidth sample, thus allowing the second user to preview the multi-frame video prior to downloading the multi-frame video. A request for the multi-frame video may be received from the second user. In response to receiving the request, the multi-frame video may be provided to the second user.

The reduced-bandwidth sample of the multi-frame video may be an animated GIF file. The plurality of video frames may be interspersed throughout the multi-frame video. The plurality of video frames may be evenly spaced throughout the multi-frame video. The reduced-bandwidth sample may be configured to be rendered on a wireless client electronic device. The first user and the second user may be members of a social network. The second user may be wirelessly coupled to the social network.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a bandwidth reduction process according to an implementation of the present disclosure;

FIG. 2 is a flowchart of the bandwidth reduction process of FIG. 1 according to an implementation of the present disclosure;

FIG. 3 is a diagrammatic representation of the generation of a reduced-bandwidth sample by the bandwidth reduction process of FIG. 1 according to an implementation of the present disclosure; and

FIGS. 4A-4E are diagrammatic representations of the various methodologies of providing the reduced-bandwidth sample of FIG. 3 according to an implementation of the present disclosure.

Like reference symbols in the various drawings indicate like elements.

### DETAILED DESCRIPTION OF THE PREFERRED EMBODIMENTS

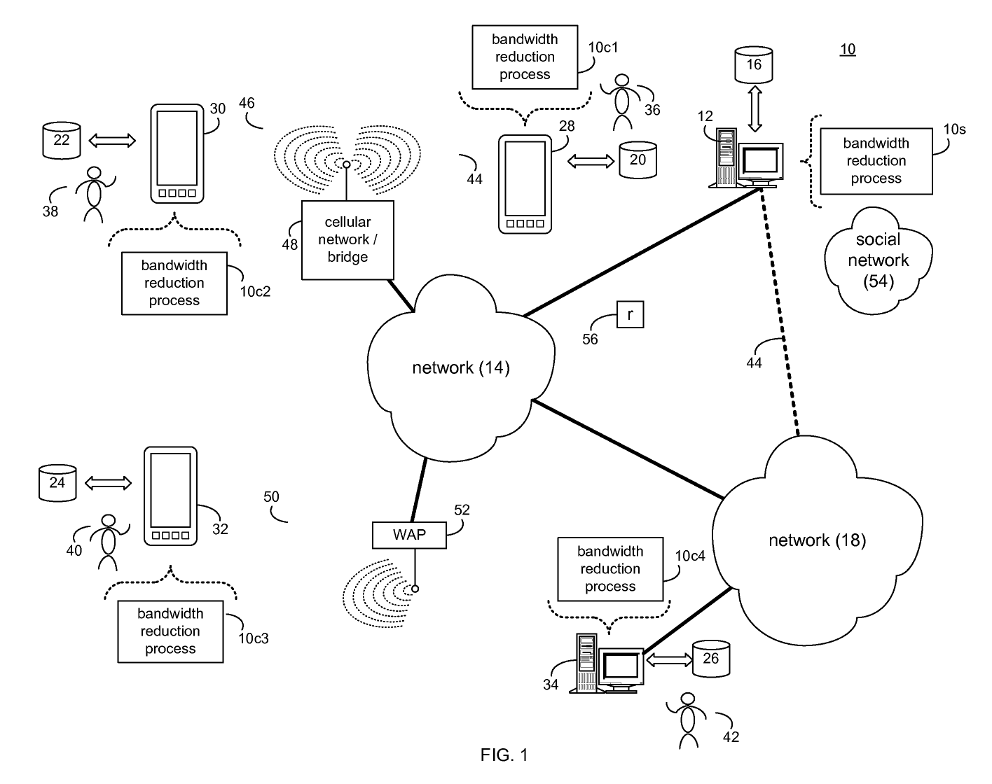

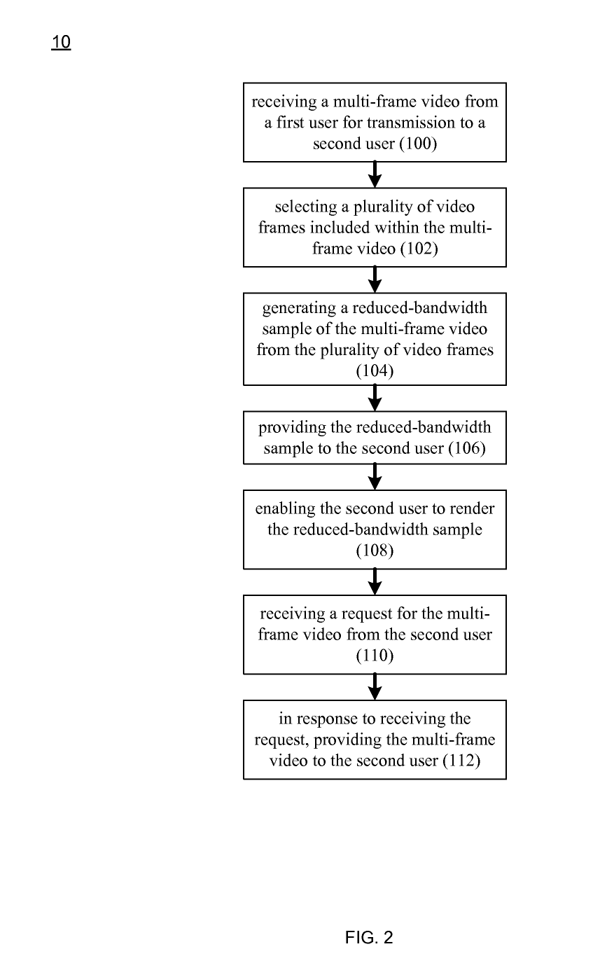

In FIGS. 1-2, there is shown bandwidth reduction process 10. Bandwidth reduction process 10 may be implemented as a server-side process, a client-side process, or a hybrid server-side/client-side process. For example, bandwidth reduction process 10 may be implemented as a purely server-side process via bandwidth reduction process 10s. Alternatively, bandwidth reduction process 10 may be implemented as a purely client-side process via one or more of bandwidth reduction process 10c1, bandwidth reduction process 10c2, bandwidth reduction process 10c3, and bandwidth reduction process 10c4. Alternatively still, bandwidth reduction process 10 may be implemented as a hybrid server-side/client-side process via bandwidth reduction process 10s in combination with one or more of bandwidth reduction process 10c1, bandwidth reduction process 10c2, bandwidth reduction process 10c3, and bandwidth reduction process 10c4. Accordingly, bandwidth reduction process 10 as used in this disclosure may include any combination of bandwidth reduction process 10s, bandwidth reduction process 10c1, bandwidth reduction process 10c2, bandwidth reduction process 10c3, and bandwidth reduction process 10c4.

As will be discussed below in greater detail, bandwidth reduction process 10 may receive 100 a multi-frame video from a first user for transmission to a second user and select 102 a plurality of video frames included within the multi-frame video. Bandwidth reduction process 10 may generate 104 a reduced-bandwidth sample of the multi-frame video from the plurality of video frames and provide 106 the reduced-bandwidth sample to the second user.

Bandwidth reduction process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of bandwidth reduction process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of bandwidth reduction processes 10c1, 10c2, 10c3, 10c4 may include but are not limited to a web browser, a game console user interface, a video conference user interface, a social network user interface, or a specialized application. The instruction sets and subroutines of bandwidth reduction processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, data-enabled, cellular telephone 30, personal digital assistant 32, personal computer 34, a laptop computer (not shown), a notebook computer (not shown), a server computer (not shown), a gaming console (not shown), a television (not shown), a tablet computer (not shown) and a dedicated network device (not shown). Client electronic devices 28, 30, 32, 34 may each execute an operating system.

Users 36, 38, 40, 42 may access bandwidth reduction process 10 directly through network 14 or through secondary network 18. Further, bandwidth reduction process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and data-enabled, cellular telephone 30 are shown wirelessly coupled to network 14 via wireless communication channels 44, 46 (respectively) established between data-enabled, cellular telephone 28, data-enabled, cellular telephone 30 (respectively) and cellular network/bridge 48, which is shown directly coupled to network 14. Further, personal digital assistant 32 is shown wirelessly coupled to network 14 via wireless communication channel 50 established between personal digital assistant 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between personal digital assistant 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

As is known in the art, users of social networks (e.g., social network 54) may be able to participate in group communication sessions that may enable e.g., the various users of social network 54 to exchange photographs and videos. For the following discussion, bandwidth reduction process 10 may be included within social network 54, a portion of social network 54, utilized by social network 54 and/or a stand-alone application that interfaces with social network 54.

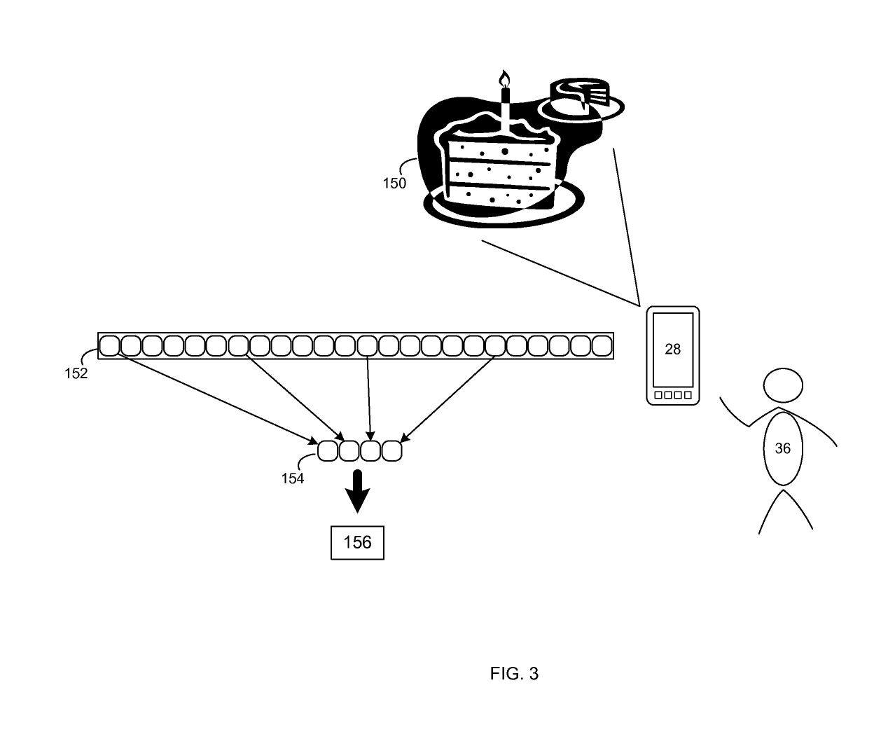

Referring also to FIG. 3, assume for illustrative purposes that users 36, 38, 40, 42 are all members of social network 54. Further assume that user 36 is attending birthday party 150 and records a video (e.g., video 152) of all or a portion of the same. Additionally, assume that user 36 wishes to share video 152 with user 38 and, therefore, would like to provide user 38 with a copy of video 152. As discussed above, when sending videos (e.g., video 152) between users (e.g., users 36, 38) within a social network (e.g., social network 54), these videos (e.g., video 152) are typically only viewable by the intended recipient (e.g., user 38) once e.g., video 152 has been completely downloaded. Further complicating the situation is that, had the intended recipient (e.g., user 38) been able to preview video 152 prior to downloading the same, user 38 may have decided that they were not interested in video 152 and, therefore, may have chosen not to have downloaded the same.

Accordingly, bandwidth reduction process 10 may be configured to enable (in this example) user 38 to preview video 152 (before downloading it), thus allowing user 38 to choose not to download video 152 if they are not interested in it.

Therefore and continuing with the above-stated example, assume that user 36 initiated the transfer of a copy of video 152 to user 38. Accordingly, video 152 may be uploaded (from data-enabled, cellular telephone 28 to bandwidth reduction process 10), so that video 152 may be provided to user 38. For the following example, video 152 is visually shown to include twenty-four video frames. However, this is for illustrative purposes only and is not intended to be a limitation of this disclosure, as other configurations are possible. For example, video 152 may include hundreds or thousands of video frames.

Upon receiving 100 a multi-frame video (e.g., video 152) from a first user (e.g., user 36) for transmission to a second user (e.g., user 38), bandwidth reduction process 10 may select 102 a plurality of video frames (e.g., video frames 154) included within the multi-frame video (e.g., video 152). This plurality of video frames (e.g., video frames 154) will be a quantity that is smaller than the quantity of video frames included within the original video (e.g., video 152). Accordingly and in this example, video 152 is shown to include twenty-four video frames and the plurality of video frames (e.g., video frames 154) is shown to include four video frames. However, the quantity of video frames shown to be included within the plurality of video frames (e.g., video frames 154) is for illustrative purposes only and is not intended to be a limitation of this disclosure, as other configurations are possible.

The plurality of video frames (e.g., video frames 154) may be interspersed throughout the multi-frame video (e.g., video 154). For example, this plurality of video frames (e.g., video frames 154) may be evenly spaced throughout the multi-frame video (e.g., video 152). In this particular example, the plurality of video frames (e.g., video frames 154) is shown to include frame #1, frame #7, frame #13 and frame #19 from video 152.

Bandwidth reduction process 10 may be configured to select 102 the same quantity of frames regardless of the length/size of e.g., video 152. For example, bandwidth reduction process 10 may be configured to always select ten evenly-spaced frames interspersed throughout e.g., video 152, regardless of the length/size of video 152.

Bandwidth reduction process 10 may generate 104 a reduced-bandwidth sample (e.g., reduced-bandwidth sample 156) of the multi-frame video (e.g., video 152) from the plurality of video frames (e.g., video frames 154). Examples of reduced-bandwidth sample 156 may include but are not limited to an animated GIF file and a WebP image file. As is known, an animated GIF file is a GIF file that includes a number of discrete frames that are displayed in succession, each introduced by its own GCE (Graphics Control Extension), which allows for a time delay to occur after each frame is drawn. As is known, a WebP image file is an image file that employs both lossy and loseless compression.

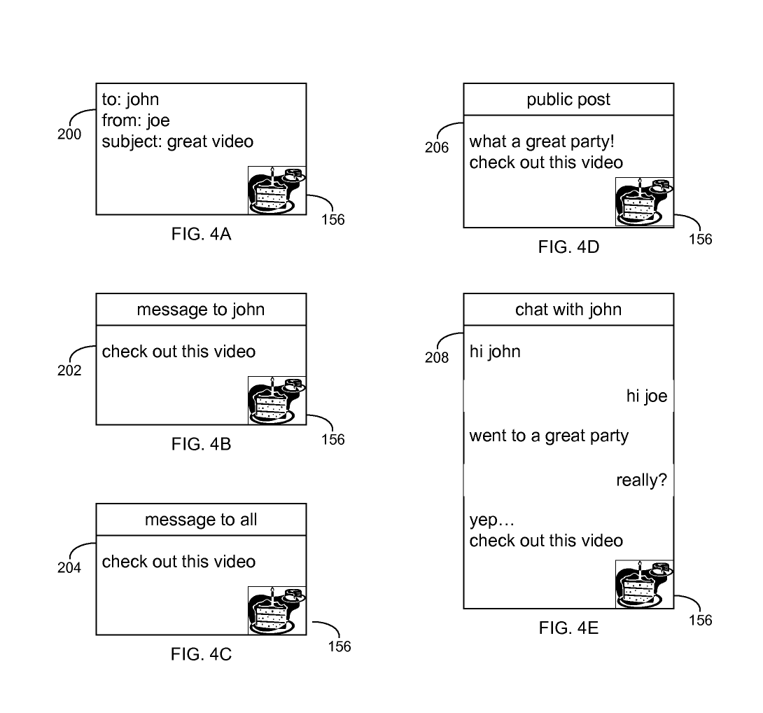

Bandwidth reduction process 10 may provide 106 reduced-bandwidth sample 156 to the second user (e.g., user 38), which may enable 108 the second user (e.g., user 38) to render reduced-bandwidth sample 156 and preview the multi-frame video (e.g., video 152) prior to downloading video 152. When providing 106 reduced-bandwidth sample 156 to user 38, reduced-bandwidth sample 156 may be provided using various methodologies, such as: an attachment to an email (e.g., email 200, FIG. 4A) within social network 54, an attachment to a private message (e.g., private message 202, FIG. 4B) within social network 54, an attachment to a public message (e.g., public message 204, FIG. 4C) within social network 54, an attachment to a post (e.g., post 206, FIG. 4D) within social network 54, and an attachment to a text-message (e.g., text-message 208, FIG. 4E) within social network 54.

The generation of reduced-bandwidth sample 156 by bandwidth reduction process 10 may result in significant bandwidth savings. For example, if video 152 was three minutes (i.e., 180 seconds) long and had a frame rate of thirty fps, video 152 would include 5,400 frames. If bandwidth reduction process 10 processed this three minute video and produced reduced-bandwidth sample 156 that is constructed from ten interspersed frames, reduced-bandwidth sample 156 may only be approximately 0.20% (i.e., 10/5,400) the size of the original three minute video (e.g., video 152). Accordingly, if the original three minute video (e.g., video 152) was twenty-megabytes in size, reduced-bandwidth sample 156 may be approximately thirty-seven kilobytes in size (thus resulting in approximately a 99.8% reduction in size).

Accordingly, reduced-bandwidth sample 156 may be provided 106 to user 38 by bandwidth reduction process 10, thus enabling 108 user 38 to preview the multi-frame video (e.g., video 152) by rendering reduced-bandwidth sample 156 prior to downloading video 152. Since (in the above-described illustrative example) reduced-bandwidth sample 156 is only approximately 0.20% the size of video 152, reduced-bandwidth sample 156 may be quickly and automatically provided to (in this example) user 38. For example, reduced-bandwidth sample 156 may be automatically rendered when user 38 views the above-described messages/posts.

In the event that, upon rendering reduced-bandwidth sample 156, user 38 is not interested in video 152, user 38 may ignore the above-described messages/posts. In the event that, upon rendering reduced-bandwidth sample 156, user 38 is indeed interested in video 152, user 38 may download video 152. For example, user 38 may select reduced-bandwidth sample 156 (by e.g., clicking on it or tapping on it) to generate a request (e.g., request 56), which may be provided to bandwidth reduction process 10.

Upon receiving 110 request 56 for the multi-frame video (e.g., video 152) from the second user (e.g., user 38), bandwidth reduction process 10 may provide 112 the multi-frame video (e.g., video 152) to the second user (e.g., user 38). Accordingly, bandwidth reduction process 10 may initiate the downloading of video 152 from e.g., computing device 12 to data enabled cellular telephone 30.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
receiving a multi-frame video from a first user for transmission to a second user;
selecting a plurality of video frames included within the multi-frame video, wherein the plurality of video frames are interspersed throughout the multi-frame video;
generating a reduced-bandwidth sample of the multi-frame video from the plurality of video frames, wherein the reduced-bandwidth sample of the multi-frame video is an animated GIF file;
providing the reduced-bandwidth sample to the second user;
enabling the second user to render the reduced-bandwidth sample, thus allowing the second user to preview the multi-frame video prior to downloading the multi-frame video;
receiving a request for the multi-frame video from the second user; and
in response to receiving the request, providing the multi-frame video to the second user.

2. A computer-implemented method comprising:
receiving a multi-frame video from a first user for transmission to a second user;
selecting a plurality of video frames included within the multi-frame video;
generating a reduced-bandwidth sample of the multi-frame video from the plurality of video frames; and
providing the reduced-bandwidth sample to the second user.

3. The computer-implemented method of claim 2 further comprising:
enabling the second user to render the reduced-bandwidth sample, thus allowing the second user to preview the multi-frame video prior to downloading the multi-frame video.

4. The computer-implemented method of claim 2 further comprising:
receiving a request for the multi-frame video from the second user.

5. The computer-implemented method of claim 4 further comprising:
in response to receiving the request, providing the multi-frame video to the second user.

6. The computer-implemented method of claim 2 wherein the reduced-bandwidth sample of the multi-frame video is an animated GIF file.

7. The computer-implemented method of claim 2 wherein the plurality of video frames are interspersed throughout the multi-frame video.

8. The computer-implemented method of claim 7 wherein the plurality of video frames are evenly spaced throughout the multi-frame video.

9. The computer-implemented method of claim 2 wherein the reduced-bandwidth sample is configured to be rendered on a wireless client electronic device.

10. The computer-implemented method of claim 2 wherein the first user and the second user are members of a social network.

11. The computer-implemented method of claim 10 wherein the second user is wirelessly coupled to the social network.

12. A computing system including a processor and memory configured to perform operations comprising:
receiving a multi-frame video from a first user for transmission to a second user;
selecting a plurality of video frames included within the multi-frame video;
generating a reduced-bandwidth sample of the multi-frame video from the plurality of video frames; and
providing the reduced-bandwidth sample to the second user.

13. The computing system of claim 12 further configured to perform operations comprising:
enabling the second user to render the reduced-bandwidth sample, thus allowing the second user to preview the multi-frame video prior to downloading the multi-frame video.

14. The computing system of claim 12 further configured to perform operations comprising:
receiving a request for the multi-frame video from the second user.

15. The computing system of claim 14 further configured to perform operations comprising:
in response to receiving the request, providing the multi-frame video to the second user.

16. The computing system of claim 12 wherein the reduced-bandwidth sample of the multi-frame video is an animated GIF file.

17. The computing system of claim 12 wherein the plurality of video frames are interspersed throughout the multi-frame video.

18. The computing system of claim 17 wherein the plurality of video frames are evenly spaced throughout the multi-frame video.

19. The computing system of claim 12 wherein the reduced-bandwidth sample is configured to be rendered on a wireless client electronic device.

20. The computing system of claim 12 wherein the first user and the second user are members of a social network.

21. The computing system of claim 20 wherein the second user is wirelessly coupled to the social network.
